(19) United States
(12) Patent Application Publication
(10) Pub. No.: US 2016/0103425 A1
(43) Pub. Date: Apr. 14, 2016

(54) Computer Implemented Method and System, and Computer Program Product, for Displaying an Intentionally Inaccurate Count of Time

(71) Applicant: Big H Ventures, LLC., Winston Salem, NC (US)

(72) Inventor: Richard A. Brenner, Winston Salem, NC (US)

(21) Appl. No.: 14/881,945

(22) Filed: Oct. 13, 2015

Related U.S. Application Data
(60) Provisional application No. 62/063,721, filed on Oct. 14, 2014.

(51) Int. Cl. G04G 9/00; G04F 1/00

(52) U.S. Cl. CPC G04G 9/00; G04F 1/005

(57) ABSTRACT

A computer implemented system and method, and a computer program product, for displaying an intentionally inaccurate count of time. For example, the method may include receiving display time information, which is comprised of information indicating an amount of time to be displayed, and receiving actual time information, which is comprised of information indicating an actual time to elapse, wherein the actual time is not equal to the display time. Actual time may be expressed as a percentage of the display time. The method also may include receiving start count information, wherein the start count information is information indicating that a count of time in an amount equal to the actual time should start. Responsive to receiving the start count information, the method may display a count of time equal to the display amount, wherein the count of time is displayed during an amount of time equal to the actual time.

### RELATED APPLICATION

The present application is related to and claims priority from U.S. Provisional Patent Application Ser. No. 62/063,721 filed Oct. 14, 2014, the contents of which are incorporated herein in their entirety.

### FIELD OF THE INVENTION

The present invention relates to a computer implemented system and method and apparatus, and a computer program product, for displaying an intentionally inaccurate count of time.

### BACKGROUND OF THE INVENTION

Conventional timekeeping devices, such as wrist watches, can be intentionally set to display an inaccurate time. For example, a watch can be set to display a time that is ahead of the actual time by ten (10) minutes. This might provide the watch wearer with the sense of having an extra ten minutes to fulfill a time sensitive obligation, such as an appointment. The time displayed by a mobile device, such as, a smartphone or a smartwatch (i.e., a digitally controlled and/or a smartphone-controlled watch), however, is limited. Typically, a user cannot adjust the actual time being kept by the device, but can only adjust, for example, the time zone for the device. Thus, a user of a smartphone clock or a smartwatch is prevented from adjusting the time of the device so as to display an intentionally inaccurate count of time. What is needed, therefore, is a system and method, and a computer program product, that allows a user to cause an intentionally inaccurate count of time to be displayed by a mobile device, such as a smartphone or a smartwatch.

### SUMMARY OF THE INVENTION

A computer implemented system and method, and a computer program product, for displaying an intentionally inaccurate count of time. For example, the method may include receiving display time information, which is comprised of information indicating a display time, wherein the display time is an amount of time to be displayed, and receiving actual time information, which is comprised of information indicating an actual time to elapse, wherein the actual time is an actual amount of time to be counted, and wherein the actual time is not equal to the display time. Actual time information may be expressed as a percentage of the display time. The method also may include receiving start count information, wherein the start count information is information indicating that a count of time in an amount equal to the actual time should start. Responsive to receiving the start count information, the method may display a count of time equal to the display amount, wherein the displayed count of time is displayed during an amount of time equal to the actual time. The method also may include receiving display mode information, which is comprised of information indicating a mode for displaying the count of time, and displaying the count of time in a mode indicated in the display mode information, such as a graphic mode or a digital mode. The method also may cause the count of time to be displayed simultaneously in a digital mode and a graphical mode. During the count of time, the displayed time can be changed without displaying the actual time information.

It will be appreciated that the above Summary is provided merely for purposes of summarizing some example embodiments so as to provide a basic understanding of some aspects of the disclosure. As such, it will be appreciated that the above described example embodiments are merely examples of some embodiments and should not be construed to narrow the scope or spirit of the disclosure in any way. It will be appreciated that the scope of the disclosure encompasses many potential embodiments, some of which will be further described below, in addition to those here summarized. Further, other aspects and advantages of embodiments disclosed herein will become apparent from the following detailed description taken in conjunction with the accompanying drawings which illustrate, by way of example, the principles of the described embodiments.

### BRIEF DESCRIPTION OF THE DRAWINGS

FIG. 1 is a flow chart for a process for displaying an intentionally inaccurate count of time, according to an exemplary embodiment.

FIG. 2A and FIG. 2B are screenshots of a mobile device executing an application for displaying an intentionally inaccurate count of time, wherein the application is displaying a settings interface for receiving display time and actual time information, according to an exemplary embodiment.

FIG. 3 is a screenshot of a mobile device executing an application for displaying an intentionally inaccurate count of time, wherein the application is displaying a graphic mode interface, according to an exemplary embodiment.

FIG. 4 is a screenshot of a mobile device executing an application for displaying an intentionally inaccurate count of time, wherein the application is displaying a digital mode interface, according to an exemplary embodiment.

FIG. 5 is a screenshot of a mobile device executing an application for displaying an intentionally inaccurate count of time, wherein the application is displaying a display time only interface, according to an exemplary embodiment.

FIG. 6 is a screenshot of a mobile device executing an application for displaying an intentionally inaccurate count of time, wherein the application is displaying a digital count down interface, according to an exemplary embodiment.

FIG. 7 is a screenshot of a mobile device executing an application for displaying an intentionally inaccurate count of time, wherein the application is displaying a graphic count down interface, according to an exemplary embodiment.

FIG. 8 is a screenshot of a mobile device executing an application for displaying an intentionally inaccurate count of time, wherein the application is displaying a timer done message 802, according to an exemplary embodiment.

FIG. 9 is a screenshot of a mobile device executing an application for displaying an intentionally inaccurate count of time, wherein the application is displaying an elapsed time adjustment interface for adjusting a display of actual time elapsed, according to an exemplary embodiment.

FIG. 10 is a screenshot of a mobile device executing an application for displaying an intentionally inaccurate count of time, wherein the application has hidden from a user the elapsed time adjustment interface, according to an exemplary embodiment.

FIG. 11 is a screenshot of a mobile device executing an application for displaying an intentionally inaccurate count of time, wherein the application is displaying actual time elapsed, as adjusted via the elapsed time adjustment interface illustrated in FIG. 9, according to an exemplary embodiment.

FIG. 12 is a schematic diagram of a mobile computing device, such as a smartphone, for executing an application for displaying an intentionally inaccurate count of time, according to an exemplary embodiment.

### DETAILED DESCRIPTION OF THE PREFERRED EMBODIMENTS

The present invention will now be described more fully hereinafter with reference to the accompanying drawings, in which a preferred embodiment of the invention is shown. This invention may, however, be embodied in many different forms and should not be construed as limited to the embodiments set forth herein; rather, this embodiment is provided so that this disclosure will be thorough and complete and will fully convey the scope of the invention to those skilled in the art. Like numbers refer to like elements throughout.

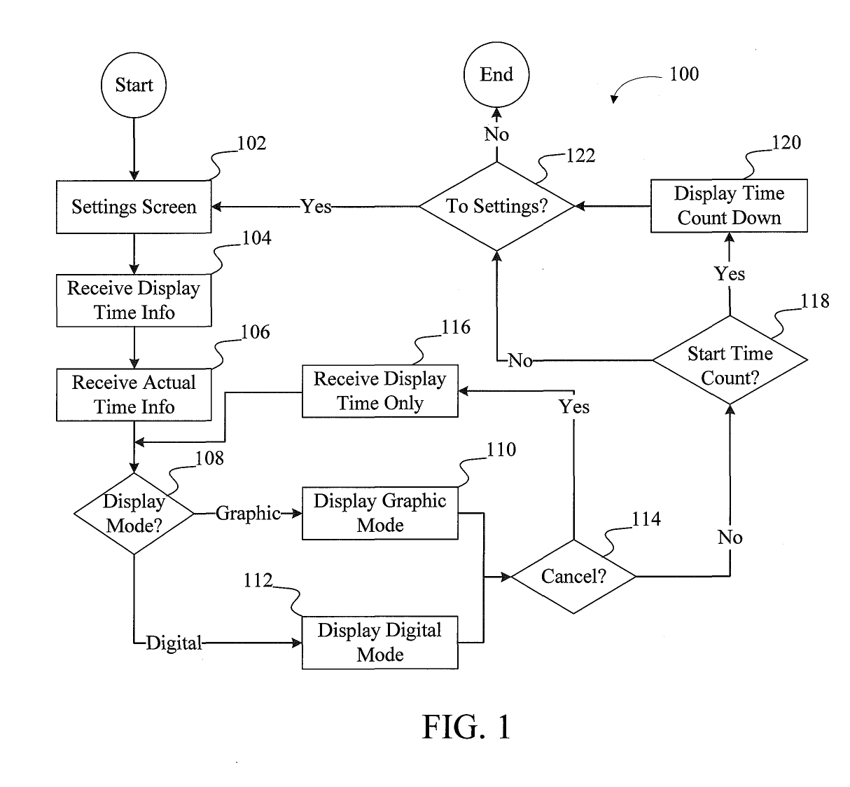

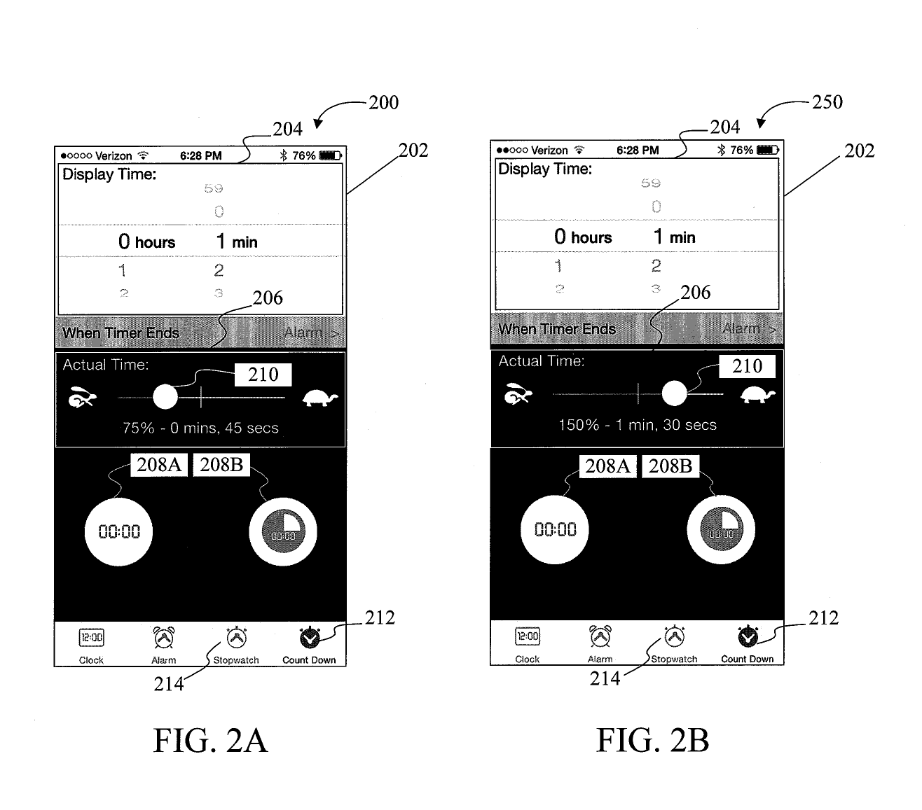

FIG. 1 is a flow chart for a process 100 for displaying an intentionally inaccurate count of time, according to an exemplary embodiment. For example, process 100 may be executed by an application (“app”) running on a mobile device, such a smartphone or a smartwatch. Thus, the app may down loaded from an online app store, and installed on a mobile device by a user. After the app is installed and launched, the process 100 illustrated in FIG. 1 is executed by the app. Beginning with operation 102, process 100 displays a settings interface. Screenshots 200 and 250 of a settings interface 202 for an application for displaying an intentionally inaccurate count of time are illustrated in FIGS. 2A and 2B, according to an exemplary embodiment.

In operation 104, process 100 may receive display time information from a user via settings interface 202. In some exemplary embodiments, display time information can be received from a user via the interface illustrated in FIGS. 2A and 2B. Display time information is information indicating an amount of time to be displayed by process 100. As shown, in FIGS. 2A and 2B, the Display Time 204 is set at one (1) minute.

In operation 106, process 100 may receive actual time information from a user. As may be appreciated, the present invention is not necessarily limited to the exemplary sequence of operations illustrated in FIG. 1 and operations 104 and 106 can be performed in any order, or simultaneously.

Actual time information also can be received via user interface 202. As shown in FIG. 2A, Actual Time 206 is set to be 75% of the Display Time 204 of one (1) minute, which is 45 seconds. In FIG. 2B, Actual Time 206 is set to be 150% of the Display Time 204 of one (1) minute, which is one (1) minute thirty (30) seconds. As shown in FIGS. 2A and 2B, in an exemplary embodiment, Actual Time 206 may be expressed as a percentage of the Display Time 204, and the percentage may be set using a slider 210. In such an embodiment, the actual time as a percentage of display time increases as the slider is dragged toward the right and decreases as the slider is dragged to the left. The invention, however, is not limited to expressing the actual time as a percentage of the display time or setting the percentage using a slider, and other suitable systems and methods for doing so may be used. For example, display time could be expressed as a percentage of actual time, or both display time and actual time values could be expressed independently of each other. In another example, the actual time as a percentage of display time could decrease as the slider is dragged toward the right and increase as the slider is dragged to the left. In other exemplary embodiments, a numeric value for the actual time may be entered via an input device, such as a keyboard, and in still other exemplary embodiments, actual time information may be entered orally via a microphone of a smartphone operating voice recognition software.

Returning to FIG. 1, in operation 108, process 100 may receive display mode information. Display mode information is information indicating a mode for displaying the count of time, such as a digital mode or a graphic mode. In some exemplary embodiments, display mode information may be received from a user via interface 202, illustrated in FIGS. 2A and 2B. As shown in FIGS. 2A and 2B, a user can select a display mode by selecting digital mode button 208A or a graphic mode button 208B.

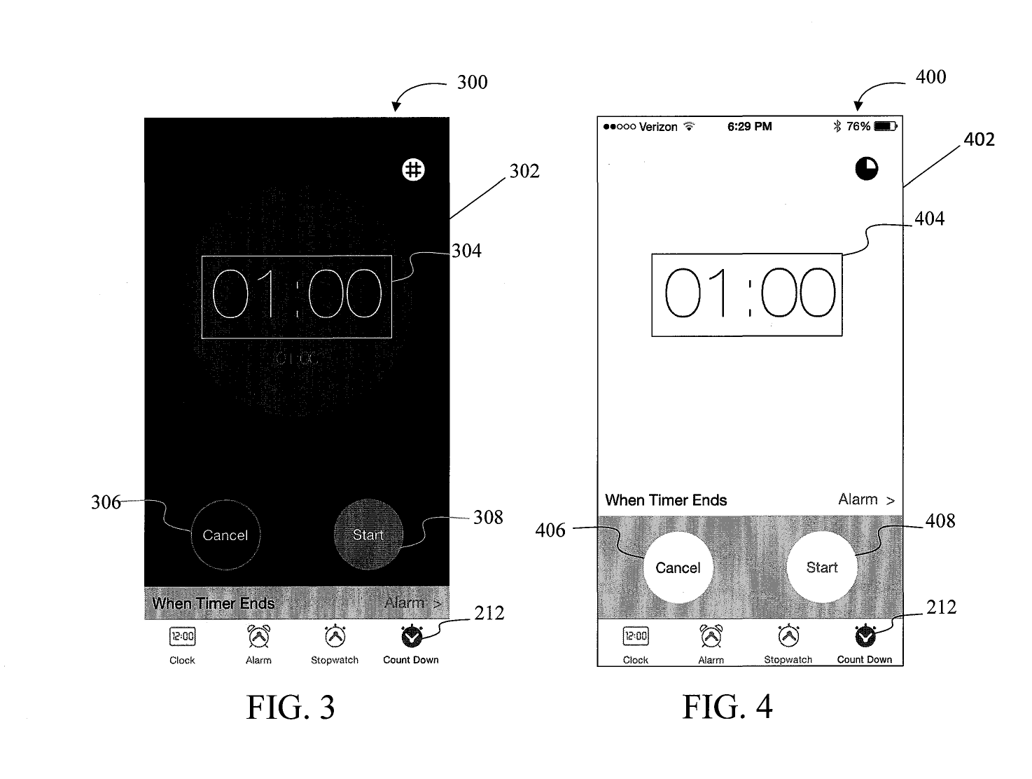

Continuing with FIG. 1, in operation 108, if process 100 receives information indicating a user has selected a graphic display mode, then process 100 causes operation 110 to execute. In operation 110, process 100 is set to display the time count in a graphic mode. In some exemplary embodiments, the display time may be displayed simultaneously in both a digital mode and a graphic mode. In some exemplary embodiments, operation 110 causes a graphic mode interface to be displayed. FIG. 3 is a screenshot 300 of a graphic mode interface 302 being displayed by a mobile device executing an application for displaying an intentionally inaccurate count of time, according to an exemplary embodiment. As shown in FIG. 3, graphic mode interface 302 displays the display time 304 that was entered via settings interface 202 illustrated in FIGS. 2A and 2B. Graphic mode interface 302 also includes a Cancel button 306 and a Start button 308.

Returning to FIG. 1, if, in operation 108, process 100 receives information indicating a user has selected a digital display mode, then process 100 causes operation 112 to execute. In operation 112, process 100 is set to display the time count in a digital mode. In some exemplary embodiments, operation 112 causes a digital mode interface to be displayed. FIG. 4 is a screenshot 400 of a digital mode interface 402 being displayed by a mobile device executing an application for displaying an intentionally inaccurate count of time, according to an exemplary embodiment. As shown in FIG. 4, display mode interface 402 displays the display time 404 that was entered via settings interface 202. Digital mode interface 402 also includes a Cancel button 406 and a Start button 408.

Continuing with FIG. 1, in operation 114, if process 100 determines if information indicating that a user has cancelled the count of time has been received. If operation 114 has received information indicating that a user has cancelled the count of time process, processing control may be transferred to operation 116. In an exemplary embodiment, a user may select Cancel buttons 306 or 406, as shown in FIGS. 3 and 4, respectively.

In operation 116, responsive to receiving information indicating that a user has cancelled a count of time process, a display-time-only interface is displayed. The display-time-only interface displays only display time information and does not display any actual time information. A display-time-only interface may be selected when a user wants to change the display time information; advantageously, the user can change the display time information via the display-time-only interface and not cause any actual time information to be displayed.

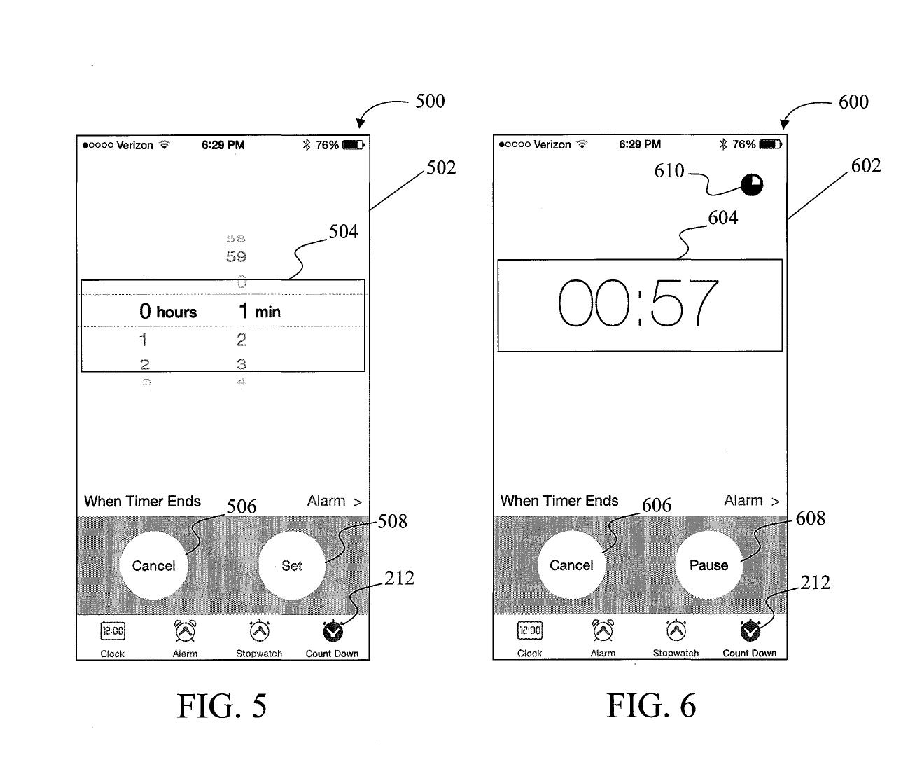

Returning to FIGS. 3 and 4, a display-time-only interface may be displayed when a user selects Cancel button 306 or 406, respectively. FIG. 5 is a screenshot 500 of a display time-only-interface 502 for an application for displaying an intentionally inaccurate count of time, according to an exemplary embodiment. As shown in FIG. 5, display-time-only interface 502 allows a user to enter display time information 504, but does not display any actual time information. Thus, while a user can adjust the display time via the display-time-only interface 502, the user cannot see or otherwise adjust the actual time. For example, if a user has entered actual time information via settings interface 202, then any display time entered via the display-time-only interface 502 will actually be displayed according to the actual time information entered via the settings interface 202.

Display-time-only interface 502 also includes a Cancel button 506 and a Set button 508. If process 100 receives information indicating a user has selected the Set button, process 100 causes a countdown of the display time to begin. If process 100 receives information indicating a user has selected Count Down button 212, process 100 causes a settings interface 200 to be displayed, which is illustrated by screenshots 200 and 250 of FIGS. 2A and 2B, respectively. It may be appreciated that actual time information 206 is displayed via settings interface 202, while actual time information is not displayed via display-time-only interface 502. Thus, by selecting either the Count Down button 212 or Cancel button 506 a user can selectively cause the display of actual time information 206, while adjusting display time information 204. Indeed, selecting the Count Down button 212, regardless of the interface otherwise being displayed by the application, will cause the settings interface 202 to be displayed.

Returning to FIG. 1, if, in operation 114, process 100 determines that it has not received information indicating a user wants to cancel a count of time, processing control is transferred to operation 118. In operation 118, process 100 determines if it has received information indicating that the count of time should be started. As mentioned above, a user may cause the count of time to start by selecting the Start button 308 or 408, as shown in FIGS. 3 and 4, respectively, or by selecting Set button 508, as shown in FIG. 5. If process 100 determines that it has received information indicating that the count of time should be started, processing control is transferred to operation 120.

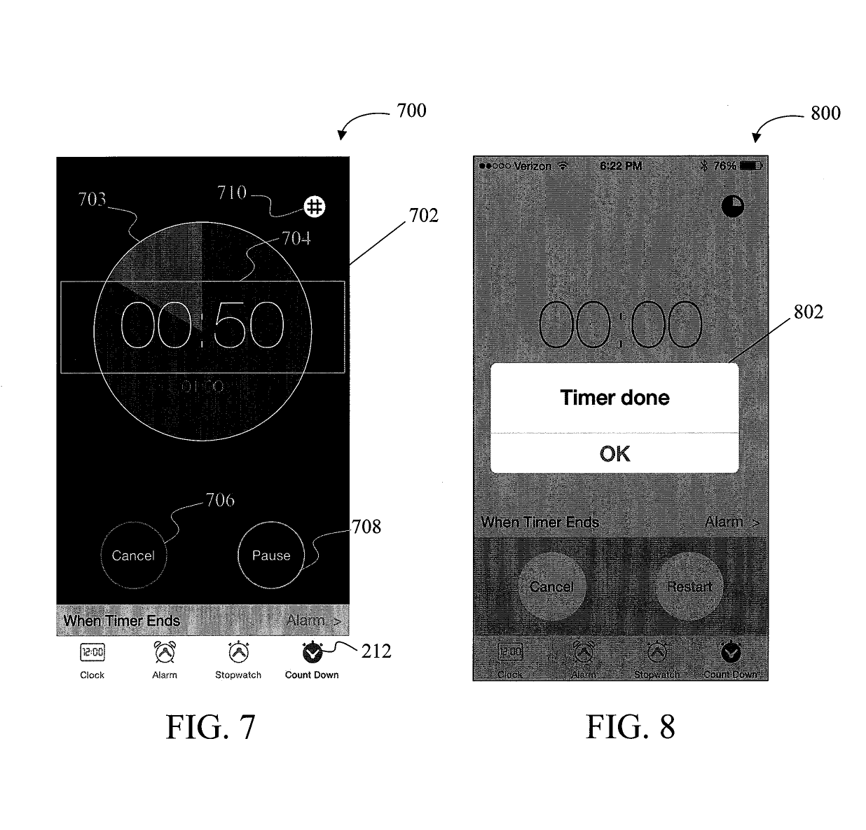

In operation 120, process 100 causes either a digital count down interface or a graphic count down interface to be displayed, depending on the mode selected via the settings interface 202. FIG. 6 is a screenshot 600 of a digital count down interface 602 and FIG. 7 is a screenshot 700 of a graphic count down interface 702, according to two exemplary embodiments. As can be seen from FIG. 6, digital count down interface 602 includes a digital count down display 604, which indicates the amount of time that remains in the time count down since the user selected the Start button 308, 408 or Set button 508. As can be seen from FIG. 7, graphic count down interface 702 includes a graphic count down display 703. Graphic count down display 703 graphically illustrates the countdown of the display time. In the exemplary graphic count down interface 702 illustrated by FIG. 7, the graphic count down display 703 is a pie chart that increases in size in proportion to the countdown of time. As shown in FIG. 7, after about 10 seconds of display time have elapsed, a corresponding amount of pie chart is displayed. In the embodiment shown in FIG. 7, the graphic count down display 703 illustrates a countdown of the display time. In other embodiments, the graphic count down display 703 could illustrate a countdown of the actual time. In the exemplary embodiment shown in FIG. 7, the graphic count down interface 702 also simultaneously displays a digital count down display 704.

Both the digital and graphic count down interfaces 602 and 702 include Cancel buttons 606, 706 and Pause buttons 608, 708. If Cancel button 606 or 706 is selected, the time count is cancelled and the display-time-only interface 502, as shown in FIG. 5, is displayed. If the Pause button 608 or 708 is selected, the time count is paused, until restarted. As shown in FIG. 6, a graphic toggle button 610 may be provided, which, if selected by a user, causes the graphic count down interface 702 of FIG. 7 to be displayed. Similarly, as shown in FIG. 7, a digital toggle button 710 may be provided, which, if selected by a user, causes the digital count down interface 602 of FIG. 6 to be displayed.

When process 100 completes the time count, information indicating the time count has been completed done may be displayed. FIG. 8 is a screenshot 800 of an application for displaying an intentionally inaccurate count of time, wherein the application is displaying a timer done message 802, according to an exemplary embodiment.

Returning to FIG. 1, if operation 118 does not receive information indicating that a count of time should be started, processing control may be transferred to operation 122. In operation 122, process 100 determines if it has received information indicating a user desires the settings interface to be displayed. In some exemplary embodiments, a user may cause the settings interface 202 to be displayed by selecting the Count Down button 212. If operation 122 determines that information indicating a user desires the settings interface to be displayed has been received, processing control is transferred to operation 102. As discussed above, in operation 102, process 100 displays a settings interface 202, as illustrated in FIGS. 2A and 2B.

If operation 118 determines that information indicating a user desires the settings interface to be displayed has not been received, processing ends.

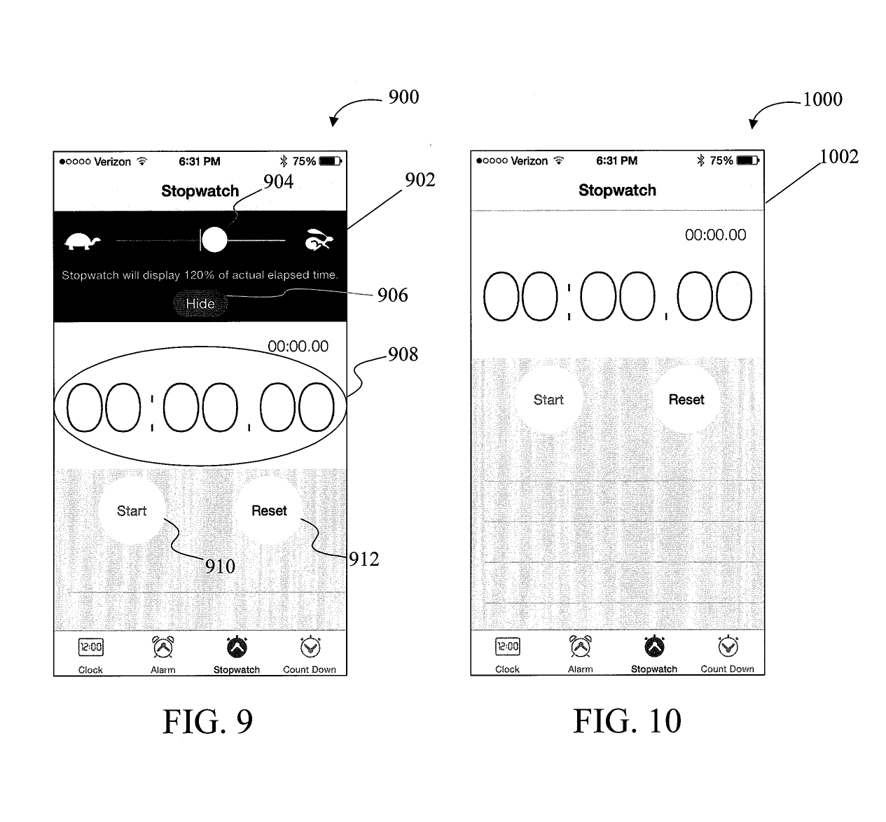

Returning to FIGS. 2A and 2B, in some exemplary embodiments, the interface to the application also includes a Stopwatch button 214. If the application receives information indicating that a user has selected Stopwatch button 214, application displays a stopwatch settings interface. FIG. 9 is a screenshot 900 of an exemplary a stopwatch settings interface 902, which can receive information adjusting the display of actual time elapsed, according to an exemplary embodiment. As shown in FIG. 9, in an example embodiment, stopwatch settings interface 902 includes a slider 904 for adjusting the amount of time to be displayed. As can be seen from FIG. 9, slider 904 has been adjusted so that 120% of the actual elapsed time will be displayed. Thus, for example, if the stopwatch indicates that 12 (twelve) minutes have elapsed, only 10 (ten) minutes of time will have actually elapsed. As may be appreciated the invention is not limited to using a slider to adjust the actual elapsed time and other suitable methods may be used.

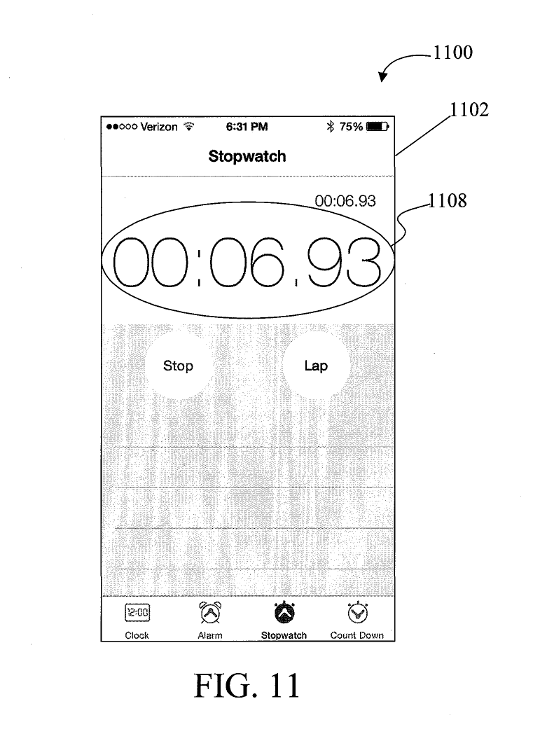

Also shown in FIG. 9 is a Hide button 906. If the application receives information indicating a user has selected Hide button 906, the application will hide slider 904. FIG. 10 is a screenshot 1000 of an application for displaying an intentionally inaccurate count of time, wherein the time adjustment slider 904 of stopwatch interface 902, as shown in FIG. 9, has been hidden from view, according to an exemplary embodiment. Interface 902 also includes a count up display 908. Count up display 908 displays an amount of time, as a percentage of the actual elapsed time set via slider 904. Stopwatch interface 902 also includes a Start button 910 and a Reset button 912. If the application receives information indicating that a user has selected Start button 910, a count up of time is displayed via count up display 908. FIG. 11 is a screenshot 1100 of an application for displaying an intentionally inaccurate count of time, wherein the application is displaying a count up interface 1102, which includes a count up display 1108. If the application receives information indicating that a user has selected Reset button 912, count up display 908 is reset to zero (0).

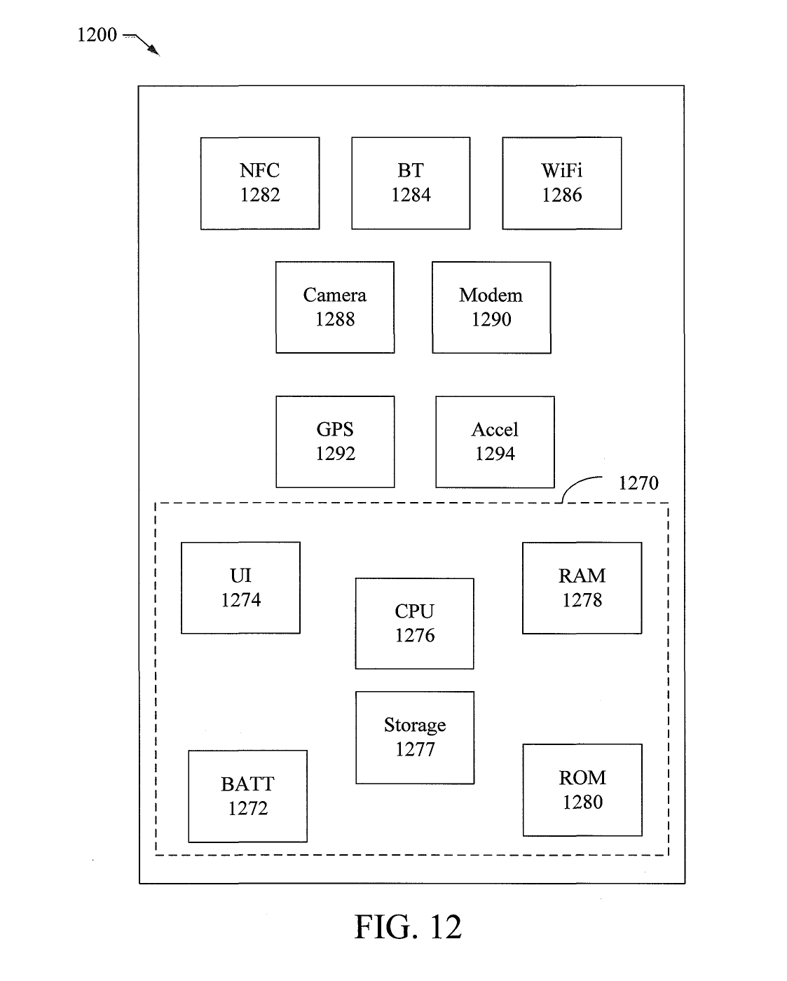

FIG. 12 is a schematic diagram of a mobile computing device 1200, such as a smartphone, for executing an application for displaying an intentionally inaccurate count of time, according to an exemplary embodiment. Mobile device 1200 typically comprises core hardware modules 1270 central to the operation of the mobile device 1200, such as a battery module 1272, user interface module 1274, a processor module 1276, non-volatile storage 1277, random access memory (RAM) 1278, and read only memory (ROM) 1280. Non-volatile storage 1277 may comprise a hard drive or flash memory for storing the operating system, various applications and data, etc. Suitable mobile operating systems include iOS operating system, available from Apple, Inc. of Cupertino, Calif. and the Android operation system, available from Google, Inc. of Mountain View, Calif. The ROM 1280 may include boot code that executes when the mobile device 1200 is initially powered or reset, and may be separate from or included as part of the processor module 1276. Initialization of the mobile device 1200 as a medical device by modifying the booting process of the mobile device 1200 is discussed further below. It should be noted that the processor module 1276 may comprise any processing circuitry (e.g., a microprocessor or a microcontroller), may comprise more than one processing core, and may be spread among multiple interconnected hardware modules.

Mobile device 1200 may also include other non-core hardware modules such as a near-field communication (NFC) module 1282, a Bluetooth module 1284, a WiFi module 1286, a camera module 1288, a cellular modem module 1290, a GPS module 1292, and an accelerometer module 1294. Such non-core hardware modules are typically controlled by

Embodiments described herein may be practiced with various computer system configurations including, mobile devices, hand-held devices, tablets, microprocessor systems, microprocessor-based or programmable consumer electronics, personal computers, laptop computers, minicomputers, mainframe computers and the like. Some embodiments may also be practiced in distributed computing environments where tasks are performed by remote processing devices that are linked through one or more networks, such as one or more wireline networks and/or one or more wireless networks.

A computer program product may be used to implement an application for displaying an intentionally inaccurate count of time, in some example embodiments. A computer program product embodiment may include a machine-readable, non-transitory (non-volatile) storage medium (media) having instructions stored thereon/in, which can be used to program a computer to perform any of the processes of the embodiments described herein. Computer code for operating and configuring a scoring system is preferably downloaded and stored in non-volatile memory, although the entire program code, or portions thereof, may also be stored in any other volatile or non-volatile memory medium or device as is well known, such as a read only memory (ROM) or random access memory (RAM), or provided on any media capable of storing program code, such as any type of rotating or solid state media, or any type of media or device suitable for storing instructions and/or data. Additionally, the entire program code, or portions thereof, may be transmitted and downloaded from a software source over a transmission medium, e.g., over the Internet or wirelessly, or from another server, or transmitted over any other conventional network connection as is well known (e.g. extranet, virtual private network (VPN), local area network (LAN), etc.) using any communication medium and protocols (e.g. transmission control protocol/internet protocol (TCP/IP), hypertext transport protocol (HTTP), HTTP secure (HTTPS), Ethernet, etc.). It may be appreciated that computer code for implementing embodiments of the present invention can be implemented in any programming language that can be executed on a client system and/or server or server system such as, for example, Swift, C, Objective-C, C++, hypertext markup language (HTML), any other markup language, Java™, JavaScript, ActiveX, any other scripting language, such as VBScript, and many other programming languages may be used. As may be appreciated, a software development platform, such as, the XCode platform, which is available from Apple, Inc., may be used to develop the computer code for the application for displaying an intentionally inaccurate count of time, which is described above.

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

What is claimed is:

1. A method, performed by a processor, for displaying an intentionally inaccurate count of time, the method comprising:
receiving display time information, wherein the display time information is comprised of information indicating a display time, wherein the display time is an amount of time to be displayed;
receiving actual time information, wherein the actual time information is comprised of information indicating an actual time to elapse, wherein the actual time is an actual amount of time to be counted, and wherein the actual time is not equal to the display time;
receiving start count information, wherein the start count information is information indicating that a count of time in an amount equal to the actual time should start; and
responsive to receiving the start count information, displaying a count of time equal to the display amount, wherein the displayed count of time is displayed during an amount of time equal to the actual time.

2. The method of claim 1, further comprising:
receiving display mode information, wherein the display mode information is comprised of information indicating a mode for displaying the count of time; and
displaying the count of time in a mode indicated in the display mode information.

3. The method of claim 2, wherein the display mode information is comprised of information that indicates that the count of time should be displayed in a graphic mode or a digital mode.

4. The method of claim 1, wherein the count of time is displayed simultaneously in a digital mode and a graphical mode.

5. The method of claim 1, wherein, during the count of time, the displayed time can be changed without displaying the actual time information.

6. The method of clam 1, wherein the actual time information is comprised of information expressing the actual time as a percentage of the display time.

7. A computer implemented system for intentionally displaying an inaccurate amount of time,
at least one processor; and
at least one memory storing computer program code, wherein the at least one memory and stored computer program code are configured, with the at least one processor, to cause the system to at least:
receive display time information, wherein the display time information is comprised of information indicating a display time, wherein the display time is an amount of time to be displayed;
receive actual time information, wherein the actual time information is comprised of information indicating an actual time to elapse, wherein the actual time is an actual amount of time to be counted, and wherein the actual time is not equal to the display time;
receive start count information, wherein the start count information is information indicating that a count of time in an amount equal to the actual time should start; and
responsive to receiving the start count information, display a count of time equal to the display amount, wherein the displayed count of time is displayed during an amount of time equal to the actual time.

8. The system of claim 7, wherein the at least one memory and stored computer program code are configured, with the at least one processor, to further cause the system to:
receive display mode information, wherein the display mode information is comprised of information indicating a mode for displaying the count of time; and
display the count of time in a mode indicated in the display mode information.

9. The system of claim 8, wherein the display mode information is comprised of information that indicates that the count of time should be displayed in a graphic mode or a digital mode.

10. The system of claim 7, wherein the count of time is displayed simultaneously in a digital mode and a graphical mode.

11. The system of claim 7, wherein, during the count of time, the displayed time can be changed without displaying the actual time information.

12. The system of claim 7, wherein the actual time information is comprised of information expressing the actual time as a percentage of the display time.

13. A computer program product for intentionally displaying an inaccurate amount of time, the computer program product comprising at least one non-transitory computer-readable storage medium having program instructions stored thereon, which when executed by at least one processor, cause the at least one processor to perform a method comprising:
receiving display time information, wherein the display time information is comprised of information indicating a display time, wherein the display time is an amount of time to be displayed;
receiving actual time information, wherein the actual time information is comprised of information indicating an actual time to elapse, wherein the actual time is an actual amount of time to be counted, and wherein the actual time is not equal to the display time;
receiving start count information, wherein the start count information is information indicating that a count of time in an amount equal to the actual time should start; and
responsive to receiving the start count information, displaying a count of time equal to the display amount, wherein the displayed count of time is displayed during an amount of time equal to the actual time.

14. The computer program product of claim 13, wherein the least one non-transitory computer-readable storage medium having program instructions stored thereon, which when executed by the at least one processor, cause the at least one processor to perform a method further comprising:
receiving display mode information, wherein the display mode information is comprised of information indicating a mode for displaying the count of time; and
displaying the count of time in a mode indicated in the display mode information.

15. The computer program product of claim 14, wherein the display mode information is comprised of information that indicates that the count of time should be displayed in a graphic mode or a digital mode.

16. The computer program product of claim 13, wherein the count of time is displayed simultaneously in a digital mode and a graphical mode.

17. The computer program product of claim 13, wherein, during the count of time, the displayed time can be changed without displaying the actual time information.

18. The computer program product of claim 13, wherein the actual time information is comprised of information expressing the actual time as a percentage of the display time.
